(19) United States
(12) Patent Application Publication
(10) Pub. No.: US 2010/0023261 A1
(43) Pub. Date: Jan. 28, 2010

(54) PERSONALIZED MAP DISPLAY GENERATOR

(75) Inventors: Thomas F. Bitonti, Cary, NC (US); Wendell J. Bouknight, JR., Clayton, NC (US); Dana Lea Price, Cary, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/179,630

(22) Filed: Jul. 25, 2008

(51) Int. Cl. G01C 21/00

(52) U.S. Cl. 701/208

(57) ABSTRACT

Using non-personalized data sets provided by remote sources and representing specific geographic areas and locally-acquired current location data for a selected personal object, a personalized video display is generated in a client-side system. The non-personalized data sets include boundary data. The client-side system determines whether the current location is within the geographic area represented by the data set and modifies the data set to include a visible indicator representing the current location. The modified data set is rendered on a video display device. If the current location is not within the geographic area, the data set is modified to include an indicator representing the bearing of the current location relative to at least one boundary of the geographic area.

### BACKGROUND OF THE INVENTION

The present invention relates to generation of video images of maps and more particularly to generation of personalized map images.

Television broadcasters and Internet websites commonly broadcast data sets that can be used to generate displays of map images in client-side systems such as personal computers systems or television receivers.

The map images are often used to convey information that may be of immediate interest to users of the client-side systems. As one example, the map images may be used to convey the current or projected locations of weather phenomena such as severe thunderstorms, snowstorms, hurricanes and the like. As another example, the map images may be used to show the location of traffic accidents or traffic congestion.

While such map images are often provided on the premise they will be of personal interest to at least some users of client-side systems receiving the images, the map images themselves are not personalized to particular users but instead represent only a specific geographic area.

In the following description, a map image that is used to depict a specific geographic area and that lacks content personalizing it to a particular user or set of users may be referred to as a broadcast map without regard to the format of the data set that is used to generate the map image or the nature of the delivery mechanism that is used to transport the data set from its source to a using client-side system. For example, broadcast maps may be generated using data sets encoded in JPEG, TIFF, PNG, HTML and other data formats that can be used to render an image at the client-side system at which the data set is received. Similarly, a broadcast map may be distributed by using video distribution technologies (such as over-the-air broadcasts, cable distribution systems and satellite distribution systems) or by using computer network technologies, such as Asynchronous Transfer Mode or TCP/IP networks. The definition of broadcast or non-personalized maps excludes map data of the type required by users of GPS systems since such map data is ordinarily pre-loaded into a GPS receiver prior to use of the GPS received rather than being broadcast or made dynamically available to the user in the course of use.

Even though content providers provide broadcast maps on the premise that such maps will be of personal interest to users of client-side systems, the reality is that such maps may be of limited usefulness to a user who has no idea where his current location is relative to the received map image. Even if received map image include landmarks such as roads, lakes, rivers, etc., the user may not be familiar enough with those landmarks to deduce his current location on the map.

### BRIEF SUMMARY OF THE INVENTION

The present invention may be implemented as a method for generating a video display of a non-personalized map with an overlaid personal object indicator indicating the current location of the selected personal object; e.g., a person. A non-personalized video data set is received. The data set represents a predetermined geographic area and includes boundary data defining the boundaries of the predetermined geographic area. Other data is received that defines the current location of a personal object. A determination is made whether the current location is within the boundaries of the predetermined geographic area. If it is determined that the current location is within the boundaries, the received non-personalized video data set is modified to include a visible indication of the current location.

The present invention may also be implemented as a computer program product for generating a video display that includes a non-personalized map and an overlaid personal object indicator. The computer program product includes a computer usable medium embodying computer usable program code that is configured to receive a non-personalized video data set representing a predetermined geographic area and including boundary data defining the boundaries of the predetermined geographic area, to receive data defining the current location of a personal object, to determine whether the current location is within the boundaries of the predetermined geographic area and, if so, to modify the received non-personalized video data set to include a visible indication of the current location.

The present invention may also be implemented as a system for generating a video display that includes a non-personalized map and a personal object indicator overlaid on the non-personalized map. The system includes a video display device and a display controller for providing video data to be displayed on the video display device. The system further includes a receiving subsystem for receiving a non-personalized video data set representing a predetermined geographic area. The data set includes boundary data defining the boundaries of the predetermined geographic area. The system also includes a personal location detector subsystem for receiving data representing the current location of the personal object (e.g., a person) and a personalized map generator subsystem that receives inputs from both the receiving subsystem and the personal location detector subsystem. The personalized map generator subsystem determines whether the current location of the personal object is within the boundaries of the predetermined geographic area. If so, the personalized map generator subsystem modifies the non-personalized data set to include a visible indication of the current location.

### BRIEF DESCRIPTION OF THE SEVERAL VIEWS OF THE DRAWINGS

FIG. 1 is a high-level overview of major systems employed in implementing the present invention.

FIG. 2 is an illustration of a rendered broadcast map of the type that may be used in implementations of the present invention.

FIG. 3 is a block diagram of a major functional components of a broadcast map source.

FIG. 4 is a block diagram of the client-side system that may be used in implementations of the present invention.

FIG. 5 is an illustration of a video display produced when a current location does not fall within a predetermined geographic area.

FIG. 6, consisting of FIGS. 6A and 6B, is a flow chart of basic operations performed in the client-side system.

FIG. 7 is a block diagram of the basic components of a general purpose computer system that could be programmed to perform the functions of the broadcast map source and/or the client-side system.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

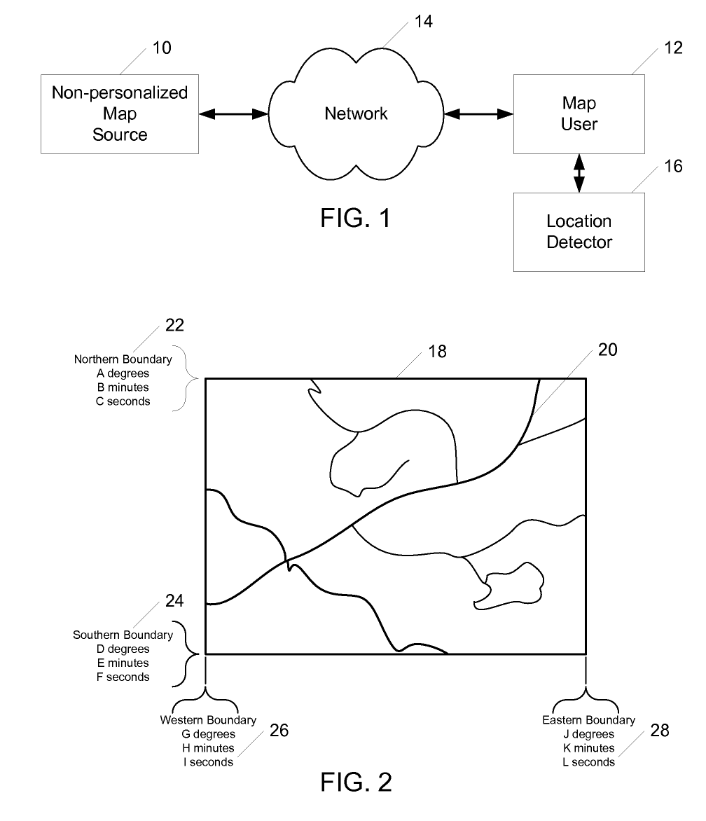

Referring now to FIG. 1, the major components required for any implementation of the present invention include a source system 10 capable of providing data sets representing predetermined geographic areas, a user system 12, and an intervening network 14 for transporting data sets from the source system 10 to the user system 12. Another major component is a location detector system 16 capable of providing data to the user system 12 where the data represents the current geographic location of a selected personal object.

The term “personal object” is intended to be a generic descriptor that can include users of the user system 12, other persons, a movable object such as an automobile, truck or airplane, or even a stationary location such as a home or business. The only requirement for any entity to be treated as a personal object is that there must be some way to determine the current location of the entity.

The term “location detector” is also intended to be a generic descriptor for any system capable of providing location information for selected personal object. The most widely known example of a location detector is a satellite-based Global Positioning System, commonly known as a GPS system, but other types of systems may also be used as a location detector. For example, systems exist to determine at least the approximate location of a cell phone user by triangulating signals received at different cellular system towers from the same cell phone. Moreover, a location detector function even be performed by the use of global coordinates preprogrammed into the user system 12 or downloaded into the user system as a result of the data calls to other users or Internet address searches and the like. Preprogrammed or downloaded global coordinates are usefully primarily for being able to show fixed locations on a generated map image.

While FIG. 1 shows a direct connection between the user system 12 in the location detector system 16, it should be apparent from the foregoing that systems 12 and 16 may, depending upon the technology employed, be indirectly connected through a network such as network 14.

FIG. 2 is an illustration of a map 18 that can be rendered on a video display using a non-personalized data set. The map image would typically include at least a network of roads, such as road 20, and may include other landmarks, such as rivers, lakes, etc., none of which are illustrated in the map 18. For purposes of the present invention, the data set that includes the data rendered to provide the map image will further include boundary data that defines the geographic boundaries of the geographic area represented by the map. In FIG. 2, the boundary data is represented by a northern boundary data set 22, a southern boundary data set 24, a western boundary data set 26 and an eastern boundary data set 28. In at least one embodiment of the present invention, each of these data sets would include values for the degrees, minutes and seconds of the two latitudes at the northern and southern boundaries, respectively, and values for the degrees minutes and seconds of the two longitudes at the western and eastern boundaries, respectively.

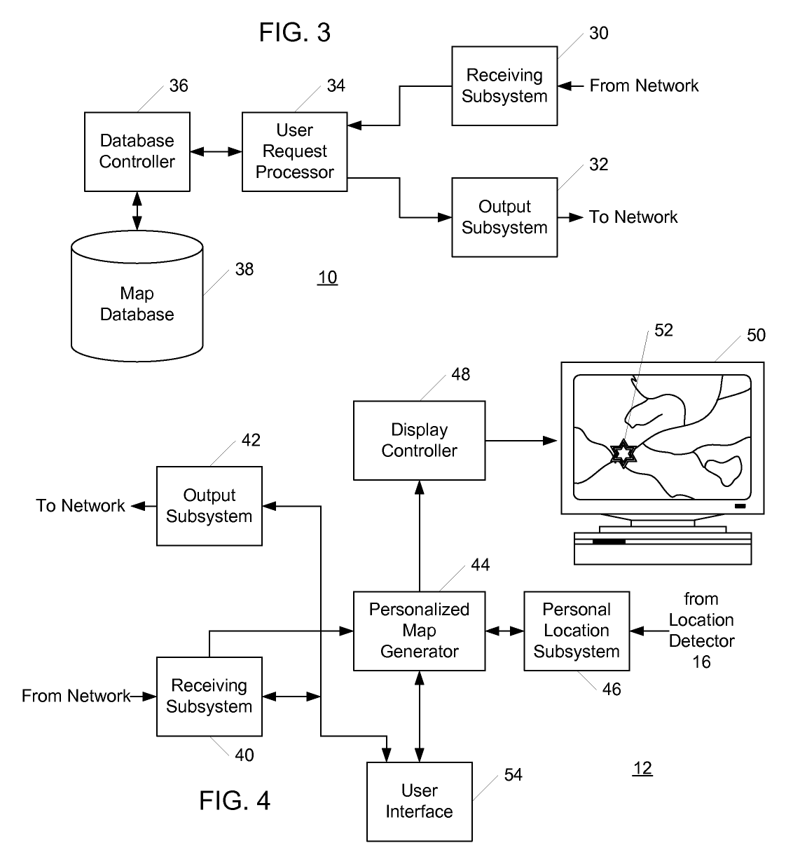

FIG. 3 is a block diagram of source system 10. The source system 10 includes a receiving subsystem 30 for receiving requests for non-personalized maps from remote users through an intervening network, an output subsystem 32 for sending requested non-personalized maps to remote users through the intervening network, and a user request processor 34 for handling both received requests and responses to those requests. The user request processor 34 is connected to a database controller 36 that provides an interface to a map database 38 containing data sets that can be used to render maps of predetermined geographic areas. As noted earlier, each data set will include associated boundary data defining the boundaries of any map representing the predetermined geographic area.

FIG. 4 is a block diagram of client-side system 12 that can be used to generate displays of personalized maps beginning with the non-personalized maps provided by source system 10. The client-side system 12 includes a user interface subsystem 54, a receiving subsystem 40 for receiving non-personalized map data sets from the source system 10 as well as an output subsystem 42 for sending requests for such data sets to the source system 10. The client-side system 12 also includes a personalized map generator component 44 that receives the non-personalized map data sets and is also connected to a personal location subsystem 46 that provides an interface to the location detector 16. The primary functions of component 44 are to receive inputs representing the map of a predetermined geographic area and the current location of the selected personal object; for example, the person actually using the client-side system, to determine whether the current location is within the boundaries of the predetermined geographic area and to modify the received video data set appropriately.

Modified data sets are provided to a display controller 48 for a video display device 50, such as a personal computer monitor. If component 44 determines that the current location of the selected personal object is within the boundaries of the map represented by the received data set, the display generated on device 50 will include the rendered non-personalized map image with an overlaid indicator 52 that represents the position of the selected personal object.

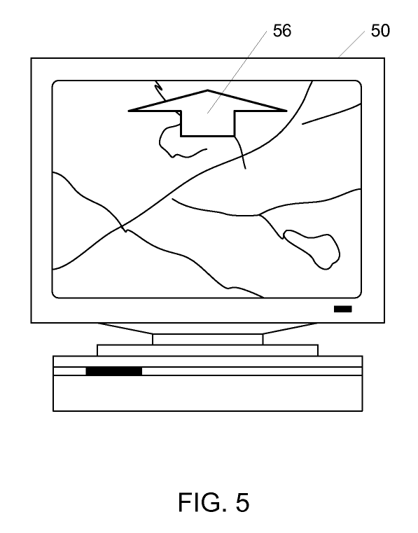

If the component 44 determines that the current location of the selected personal object is not within the boundaries of the currently-received map, the received data set is modified to provide a different display, shown in FIG. 5. The different display will include rendered non-personalized map display as before but will now include a bearing indicator 56 that indicates the relative bearing of the current location relative to at least one boundary of the map. In the Figure, bearing indicator 56 is a north-facing arrow that indicates the current location is in a geographic area to the north of the current geographic area.

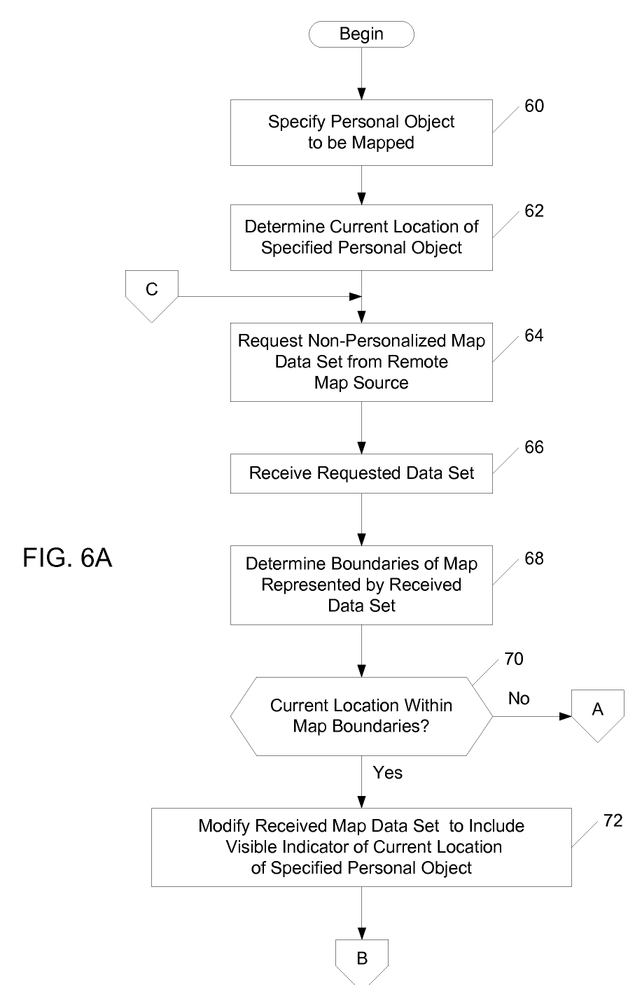

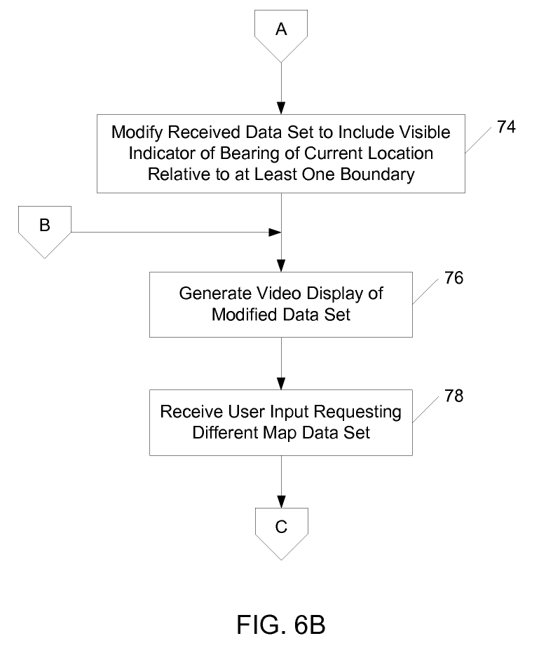

FIG. 6 is a flow chart of basic operations that are performed in the client-side system 12. In an initial operation 60, the personal object to be mapped must be selected by the user of the client-side system. As noted earlier, the personal object may be the user of the client-side system or another person or a vehicle or even the location of a home or business. Once a personal object is selected, the current location of that personal object is detected in an operation 62, typically based on input from an external system such as a GPS system. A data set representing a map of a predetermined geographic area is requested from a remote map source system and an operation 64 and then received in operation 66.

The client-side system determines the boundaries of the map represented by the received data set in an operation 68 and then determines, in an operation 70, whether the current location of the specified personal object falls within those boundaries.

If it is determined that the current location falls within the boundaries of the map represented by the current data set, the data set is modified in an operation 72 to include a visible indicator of the current location within the map. If it is determined, in operation 70, that the current location does not fall within the boundaries of the current map, the date is set is modified in an operation 74 to include a visible indicator representing the bearing of the current location related to a least one boundary of the map.

The video data set, whether modified in accordance with operation 72 or operation 74 is used to generate a video display on the video display device and an operation 76. The client-side system user is then given an opportunity 78 to enter a request for a different map data set.

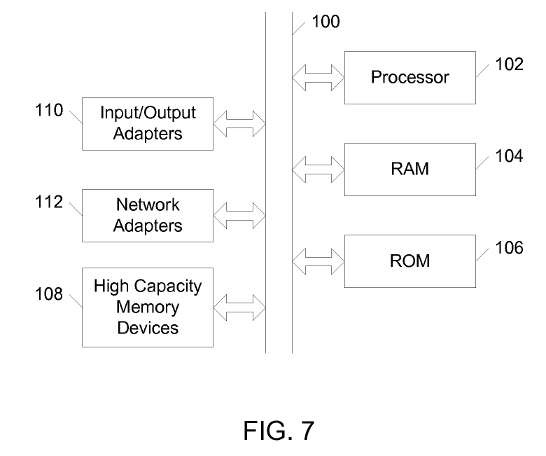

While the functions of both the map source system and the client-side system can be performed in specialized hardware, many of the functions can also be performed in a properly-programmed general purpose computer system of the type illustrated in FIG. 7.

FIG. 7 is a block diagram of a hardware infrastructure for a general-purpose computer device that could, when programmed properly, be used to implement the present invention. The infrastructure includes a system bus 100 that carries information and data among a plurality of hardware subsystems including a processor 102 used to execute program instructions received from computer applications running on the hardware. The infrastructure also includes random access memory (RAM) 104 that provides temporary storage for program instructions and data during execution of computer applications and are read only memory (ROM) 106 often used to store program instructions required for proper operation of the device itself, as opposed to execution of computer applications. Long-term storage of programs and data is provided by high-capacity memory devices 108, such as magnetic hard drives or optical CD or DVD drives.

In a typical computer system, a considerable number of input/output devices are connected to the system bus 100 through input/output adapters 110. Commonly used input/output devices include monitors, keyboards, pointing devices and printers. Increasingly, high capacity memory devices are being connected to the system through what might be described as general-purpose input/output adapters, such as USB or FireWire adapters. Finally, the system includes one or more network adapters 112 that are used to connect the system to other computer systems through intervening computer networks.

It will be clear to one of ordinary skill in the art that all or part of the method of the preferred embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the preferred embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

The present invention may further suitably be embodied as a computer program product for use with a computer system. Such an implementation may comprise computer usable code in the form of a series of computer-readable instructions either fixed on a tangible medium, such as a computer usable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative, the preferred embodiment of the present invention may be realized in the form of computer implemented method of deploying a service comprising steps of deploying computer program code operable to, when deployed into a computer infrastructure and executed thereon, cause said computer system to perform all the steps of the described method.

It will be clear to one skilled in the art that many improvements and modifications can be made to the foregoing exemplary embodiment without departing from the scope of the present invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of generating a video display comprising a non-personalized map and a personal object indicator overlaid on the non-personalized map, said method comprising:
receiving a non-personalized video data set representing a predetermined geographic area, said video data set including boundary data defining the boundaries of said predetermined geographic area;
receiving data defining the current location of a personal object;
determining whether said current location is within said boundaries of said predetermined geographic area; and
responsive to a determination said current location is within said boundaries, modifying the received non-personalized video data set to include a visible indication of said current location.

2. A method according to claim 1 further comprising, responsive to a determination that said current location is not within said boundaries, generating an indication of the bearing of said current location relative to at least one boundary of said predetermined geographic area.

3. A method according to claim 2 further comprising generating a request for a different non-personalized video data set having boundaries more likely to encompass said current location.

4. A method according to claim 2 wherein the personal object represents the person currently using the video display.

5. A method according to claim 4 wherein said data representing the current location of the personal object comprises global position coordinates of the person currently using the video display.

6. A computer program product for generating a video display comprising a non-personalized map and a personal object indicator overlaid on the non-personalized map, said computer program product comprising a computer usable medium having computer usable program code embodied therewith, said computer usable program code comprising:
computer usable program code configured to receive a non-personalized video data set representing a predetermined geographic area, said video data set including boundary data defining the boundaries of said predetermined geographic area;
computer usable program code configured to receive data defining the current location of a personal object;
computer usable program code configured to determine whether said current location is within said boundaries of said predetermined geographic area; and
computer usable program code configured to, responsive to a determination said current location is within said boundaries, modify the received non-personalized video data set to include a visible indication of said current location.

7. A computer program product according to claim 6 further comprising computer usable program code configured to, responsive to a determination that said current location is not within said boundaries, generate an indication of the bearing of said current location relative to at least one boundary of said predetermined geographic area.

8. A computer program product according to claim 7 further comprising computer usable program code configured to generate a request for a different non-personalized video data set having boundaries more likely to encompass said current location.

9. A computer program product according to claim 7 wherein the personal object represents the person currently using the video display.

10. A computer program product according to claim 9 wherein said data representing said current location of the personal object comprises global position coordinates of the person currently using the video display.

11. A system for generating a video display comprising a non-personalized map and a personal object indicator overlaid on the non-personalized map, comprising:
a video display device;
a display controller for providing video data to be displayed on said video display device;
a receiving subsystem for receiving a non-personalized video data set representing a predetermined geographic area and including boundary data defining the boundaries of said predetermined geographic area;
a personal position subsystem for receiving data representing the current location of a personal object;
a personalized map generator subsystem for receiving inputs from both said receiving subsystem and said personal position subsystem, said personalized map generator subsystem determining whether said current location is within the boundaries of said predetermined geographic area and responding to a determination that said current location is within said boundaries by modifying said received non-personalized data set to include a visible indication of said current location.

12. A system according to claim 11 wherein said personalized map generator subsystem responds to a determination that said current location is not within said boundaries of said predetermined geographic area by modifying said received non-personalized data set to include a visible indication of the bearing of said current location relative to at least one boundary of said predetermined geographic area.

13. A system according to claim 12 wherein said personalized map generator subsystem further comprises:
a request generator for generating a request for a different non-personalized video data set having boundaries more likely to encompass said current location:
an output subsystem for sending the generated request to a source for non-personalized video data sets.

14. A system according to claim 15 wherein the personal object represents the person currently using the system.

15. A system according to claim 14 wherein said data representing the current location of the personal object comprises global position coordinates of the person currently using the video display.
